(19) United States
(12) Patent Application Publication
(10) Pub. No.: US 2026/0238071 A1
(43) Pub. Date: Aug. 13, 2026

(54) ELECTRIC COMPRESSOR DEVICE

(71) Applicant: MITSUBISHI HEAVY INDUSTRIES ENGINE & TURBOCHARGER, LTD., Sagamihara-shi, Kanagawa (JP)

(72) Inventors: Tsuyoshi KITAMURA, Tokyo (JP); Yasutaka AOKI, Tokyo (JP); Takaaki YOSHIZAWA, Sagamihara-shi (JP); Yuki YAKUWA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 19/160,629

(22) PCT Filed: Mar. 30, 2023
(86) PCT No.: PCT/JP2023/013105

§ 371 Date: Aug. 28, 2025

(51) Int. Cl. H02K 5/18; H02K 5/20; H02K 9/19; H02K 21/14

(52) U.S. Cl. CPC H02K 5/18; H02K 5/203; H02K 9/19; H02K 21/14

(57) ABSTRACT

This electric compressor device comprises a motor housing that accommodates a motor. Inside the motor housing, a cooling flow path through which a cooling liquid flows in the circumferential direction is formed outside the stator of the motor in the radial direction. When viewed along the circumferential direction, the axial length of the cooling flow path is at least twice the radial length of the cooling flow path. At least one rib is provided in the motor housing, the at least one rib protruding outward in the radial direction from an inner circumferential side wall surface among the wall surfaces of the motor housing that define the cooling flow path and extending in the circumferential direction.

### TECHNICAL FIELD

The present disclosure relates to an electric compressor device.

### BACKGROUND ART

In the related art, an electric compressor device provided with a motor housing in which a flow channel for a cooling liquid is formed is known. The cooling liquid flowing through the flow channel cools a stator or the like of a motor constituting the electric compressor device. For example, in a motor housing according to PTL 1, a cooling liquid channel extending in a circumferential direction is formed.

### CITATION LIST

### Patent Literature

[PTL 1] Japanese Unexamined Patent Application Publication No. 2015-209845

### SUMMARY OF INVENTION

### Technical Problem

However, a flow channel cross section of the cooling liquid channel in the motor housing has a substantially square shape. Thus, a flow speed of the cooling liquid tends to decrease. Accordingly, the electric compressor device may not be able to sufficiently exhibit cooling performance.

An object of the present disclosure is to provide an electric compressor device having improved cooling performance.

### Solution to Problem

An electric compressor device according to at least one embodiment of the present disclosure includes a rotating shaft, a compressor wheel provided on the rotating shaft, a motor for driving the rotating shaft, and a motor housing accommodating the motor, in which the motor includes a rotor fixed to the rotating shaft, and a stator that is disposed around the rotor and that is supported by the motor housing, in the motor housing, a cooling flow channel for causing a cooling liquid to flow along a circumferential direction is formed on an outer side in a radial direction with respect to the stator, in a view along the circumferential direction, a length of the cooling flow channel in an axial direction is larger than a length of the cooling flow channel in a radial direction by a factor of two or more, and at least one rib that protrudes to the outer side in the radial direction from an inner radially side wall surface of a wall surface of the motor housing defining the cooling flow channel and that extends in the circumferential direction is provided.

### Advantageous Effects of Invention

According to the present disclosure, an electric compressor device having improved cooling performance can be provided.

### BRIEF DESCRIPTION OF DRAWINGS

FIG. 1 is a schematic cross-sectional view of an electric compressor device according to one embodiment.

FIG. 2 is a partial enlarged view of FIG. 1.

FIG. 3 is a schematic graph showing a relationship between a flow rate and a heat transfer coefficient of a cooling liquid specified through simulation.

FIG. 4A is a schematic cross-sectional view of a first rib 71 constituting a rib (a first example).

FIG. 4B is a schematic cross-sectional view of the first rib 71 constituting the rib 70 (a second example).

FIG. 5 is a schematic view of a motor housing in a view along an axial direction according to one embodiment.

FIG. 6A is a schematic cross-sectional view illustrating a motor housing according to a first embodiment.

FIG. 6B is a schematic cross-sectional view illustrating a motor housing according to a second embodiment.

FIG. 6C is a schematic cross-sectional view illustrating a motor housing according to a third embodiment.

FIG. 6D is a schematic cross-sectional view illustrating a motor housing according to a fourth embodiment.

### DESCRIPTION OF EMBODIMENTS

Hereinafter, several embodiments of the present disclosure will be described with reference to the accompanying drawings. Dimensions, materials, shapes, relative disposition, and the like of components described as embodiments or illustrated in the drawings are not intended to limit the scope of the present disclosure and are merely simple descriptive examples.

For example, expressions such as “in a certain direction”, “along a certain direction”, “parallel”, “orthogonal”, “center”, “concentric”, or “coaxial” representing relative or absolute disposition not only represent such disposition in a strict sense but also represent a state of relative displacement with allowance or with an angle or a distance with which the same function is obtained.

For example, expressions such as “identical”, “equal”, and “homogeneous” representing a state of equality between objects not only represent a state of equality in a strict sense but also represent a state where allowance or a difference with which the same function is obtained is present.

For example, expressions representing shapes such as a quadrangular shape and a cylindrical shape not only represent shapes such as a quadrangular shape and a cylindrical shape in a geometrically strict sense but also represent shapes including a rough portion, a chamfered portion, and the like with which the same effect is achieved.

Meanwhile, expressions such as “being provided with”, “including”, or “having” one component are not exclusive expressions that exclude presence of other components.

The same configurations may be designated by the same reference numerals, and descriptions thereof may not be repeated.

### Overall Configuration of Electric Compressor Device 1

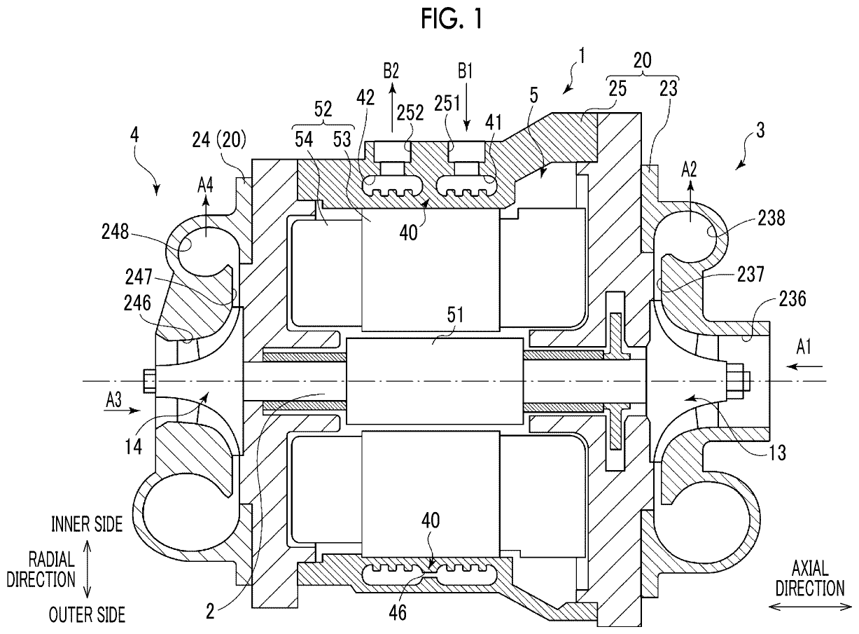

FIG. 1 is a schematic cross-sectional view of an electric compressor device 1 according to one embodiment of the present disclosure. The electric compressor device 1 of the present example is a two-stage compression electric compressor provided with a rotating shaft 2. For example, the two-stage compression electric compressor is configured to send compressed air to a fuel cell mounted in a vehicle.

In the following description, a direction in which an axis of the rotating shaft 2 extends may be referred to as an “axial direction”, and a circumferential direction and a radial direction with reference to the axis may be simply referred to as a “circumferential direction” and a “radial direction”. An outer side in the radial direction is a side in a direction away from the axis of the rotating shaft 2, and an inner side in the radial direction is a side in a direction close to the axis.

The electric compressor device 1 is provided with a housing 20 accommodating the rotating shaft 2. The housing 20 includes a low-pressure side housing 23 accommodating a low-pressure stage wheel 13 provided at one end portion of the rotating shaft 2, a high-pressure side housing 24 accommodating a high-pressure stage wheel 14 provided at the other end portion of the rotating shaft 2, and a motor housing 25 accommodating a motor 5 for driving the rotating shaft 2. In the present embodiment, the low-pressure side housing 23 and the high-pressure side housing 24 are disposed such that the motor housing 25 is interposed therebetween in the axial direction.

An intake port 236, a diffuser 237, a scroll portion 238, and a discharge port (not illustrated) are formed in the low-pressure side housing 23. Similarly, an intake port 246, a diffuser 247, a scroll portion 248, and a discharge port (not illustrated) are formed in the high-pressure side housing 24. The discharge port of the low-pressure side housing 23 is connected to the intake port 246 of the high-pressure side housing 24 through a connection pipe (not illustrated). The low-pressure side housing 23 and the low-pressure stage wheel 13 function as a low-pressure stage compressor 3, and the high-pressure side housing 24 and the high-pressure stage wheel 14 function as a high-pressure stage compressor 4. Each of the low-pressure stage wheel 13 and the high-pressure stage wheel 14 is an example of a compressor wheel.

The motor 5 includes a rotor 51 fixed to the rotating shaft 2 between the high-pressure stage wheel 14 and the low-pressure stage wheel 13, and a stator 52 disposed around the rotor 51. The rotor 51 includes a rotor core supported by the rotating shaft 2 and a plurality of permanent magnets supported by the rotor core. The stator 52 includes a stator core 53 extending in the circumferential direction and a stator coil 54 provided in the stator core 53. The stator core 53 is supported by the motor housing 25.

An operation overview of the electric compressor device 1 will be described below. A current flowing through the stator coil 54 forms a rotating magnetic field, and the rotor 51 starts rotating together with the rotating shaft 2. Accordingly, the low-pressure stage wheel 13 and the high-pressure stage wheel 14 also start rotating. In the low-pressure stage compressor 3, air enters from the intake port 236 (arrow Al). The air that has entered is accelerated by centrifugal force of the low-pressure stage wheel 13. The accelerated air is decelerated and pressurized by the diffuser 237 and then flows through the scroll portion 238 and is discharged from the discharge port (arrow A2). The low-pressure air compressed by the low-pressure stage compressor 3 is sent to the intake port 246 through the connection pipe (arrow A3). In the high-pressure stage compressor 4, the low-pressure air that has passed through the intake port 246 is accelerated by centrifugal force of the high-pressure stage wheel 14. The accelerated air is decelerated and pressurized by the diffuser 247 and then flows through the scroll portion 248 and is discharged from the discharge port (arrow A4).

While the electric compressor device 1 is performing the above operation, a current flows through the stator coil 54. Thus, a temperature of the stator 52 is increased. The temperature of the stator 52 is also increased by an eddy current generated in at least one of the stator core 53 or the stator coil 54. Therefore, in the motor housing 25 of the present example, a cooling flow channel 40 for causing a cooling liquid (not illustrated) to flow along the circumferential direction is formed on the outer side in the radial direction with respect to the stator 52.

### Overview of Cooling Flow Channel 40

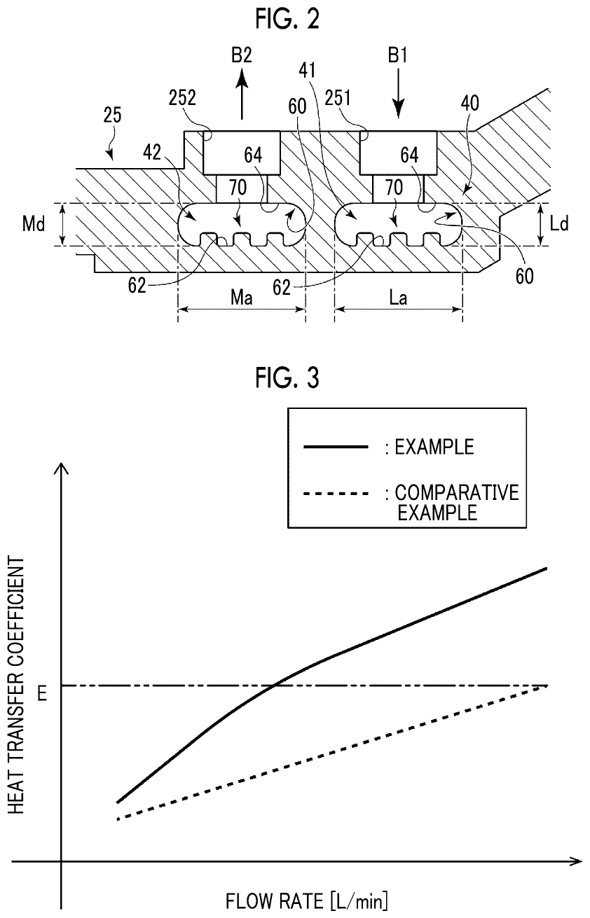

The cooling flow channel 40 according to one embodiment of the present disclosure will be described with reference to FIGS. 1 and 2. FIG. 2 is a partial enlarged view of FIG. 1. The cooling flow channel 40 of the present example includes a first cooling flow channel 41, a second cooling flow channel 42, and a first return cooling flow channel 46. The first cooling flow channel 41 and the second cooling flow channel 42 extend in the circumferential direction and are disposed to be arranged in the axial direction. The first return cooling flow channel 46 communicates with the first cooling flow channel 41 and the second cooling flow channel 42. The cooling liquid that has passed through an inlet 251 formed in the motor housing 25 flows into the first cooling flow channel 41 (arrow B1). The cooling liquid flows through the first cooling flow channel 41, the first return cooling flow channel 46, and the second cooling flow channel 42 in this order and is discharged from an outlet 252 formed in the motor housing 25 (arrow B2).

A shape of a flow channel cross section of the cooling flow channel 40 will be described. In the cooling flow channel 40 of the present example, in a view along the circumferential direction, a length of the cooling flow channel 40 in the axial direction is larger than a length of the cooling flow channel 40 in the radial direction by a factor of two or more and more specifically four or more. When a ratio of the length in the axial direction to the length in the radial direction is defined as an aspect ratio, a meaning of the length in the axial direction being larger than the length in the radial direction by a factor of N or more is the same as a meaning of the aspect ratio being 1/N or less. That is, the aspect ratio of the cooling flow channel 40 of the present example is 0.5 or less and more specifically 0.25 or less.

The aspect ratio being 0.25 or less may be established in at least a flow channel extending in the circumferential direction in the cooling flow channel 40. That is, in the examples in FIGS. 1 and 2, aspect ratios of the first cooling flow channel 41 and the second cooling flow channel 42 may be 0.25 or less. A length in the axial direction and a length in the radial direction of the first cooling flow channel 41 correspond to dimensions La and Ld, respectively, in FIG. 2. A length in the axial direction and a length in the radial direction of the second cooling flow channel 42 correspond to dimensions Ma and Md, respectively. In a case where the aspect ratio of the cooling flow channel 40 is 0.25 or less, the dimension La is larger than the dimension Ld by a factor of four or more, and the dimension Ma is larger than the dimension Md by a factor of four or more.

In the present example, a flow channel cross section of the first return cooling flow channel 46 has the same shape. More specifically, in a view along the axial direction, a length of the first return cooling flow channel 46 in the circumferential direction is larger than a length of the first return cooling flow channel 46 in the radial direction by a factor of two or more and more specifically four or more (not illustrated).

As illustrated in FIG. 2, the motor housing 25 includes at least one rib 70 extending in the circumferential direction in the cooling flow channel 40. More specifically, the motor housing 25 includes a wall surface 60 defining the cooling flow channel 40, and the wall surface 60 includes an inner radially side wall surface 62 and an outer radially side wall surface 64. The rib 70 protrudes to the outer side in the radial direction from the inner radially side wall surface 62. The rib 70 is a protruding surface configured to be integrated with the inner radially side wall surface 62. By providing the rib 70 on the inner radially side wall surface 62 instead of the outer radially side wall surface 64, the stator core 53 of which a temperature is likely to increase can be effectively cooled. The rib 70 may be provided on the outer radially side wall surface 64.

While the rib 70 according to the present embodiment is not an essential element of the present disclosure, a plurality of ribs 70 according to the present embodiment are disposed at intervals in the axial direction. As a more specific example, the rib 70 includes a plurality of first ribs 71 disposed at intervals in the axial direction in the first cooling flow channel 41, and a plurality of second ribs 72 disposed at intervals in the axial direction in the second cooling flow channel 42. Each first rib 71 and each second rib 72 extend in the circumferential direction.

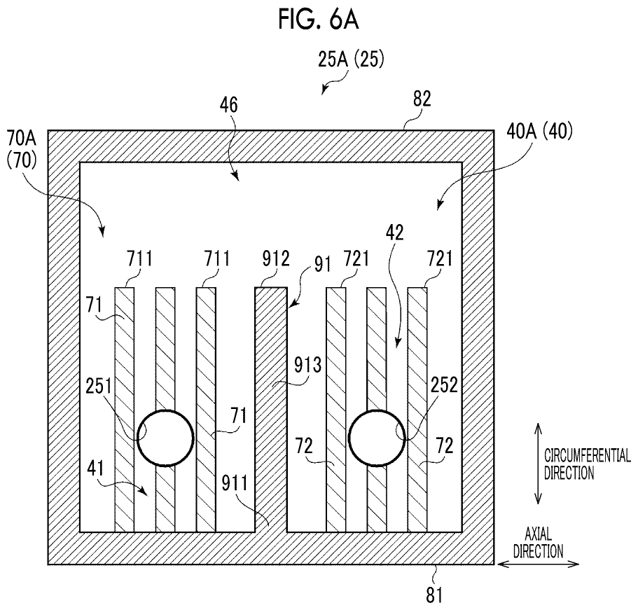

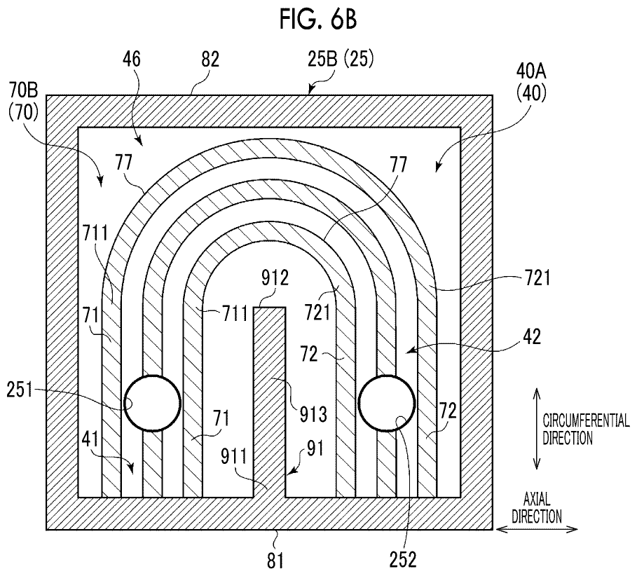

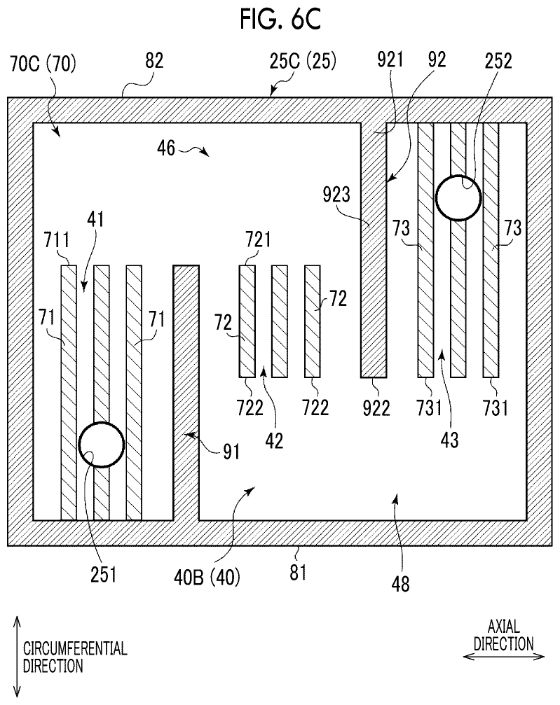

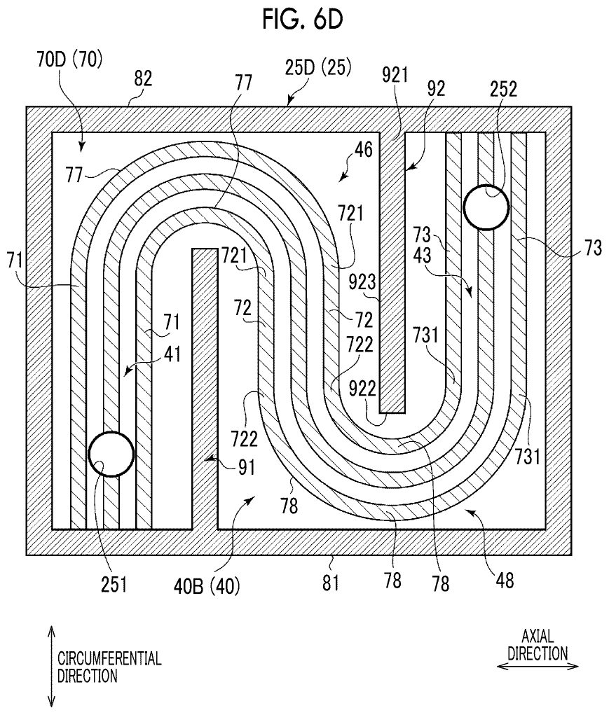

The number of ribs 70 provided in the cooling flow channel 40 extending in the circumferential direction may be two or more or may be three or more. In the illustrated example, the number of first ribs 71 disposed in the first cooling flow channel 41 is three, and the number of second ribs 72 disposed in the second cooling flow channel 42 is also three. As will be described in detail later, the rib 70 may be disposed or not disposed in the first return cooling flow channel 46 (see FIGS. 6A and 6B).

According to the above configuration, since the aspect ratio of the cooling flow channel 40 is less than 1, a flow speed of the cooling liquid in the cooling flow channel 40 is increased. In addition, a flow channel cross-sectional area is appropriately reduced by providing the at least one rib 70. Thus, the flow speed of the cooling liquid is further increased. Accordingly, a heat transfer coefficient between the cooling flow channel 40 and the cooling liquid is increased. A heat transfer area is also increased by providing the rib 70. Thus, the electric compressor device 1 having improved cooling performance is implemented. In addition, by adopting a configuration in which the plurality of ribs 70 are disposed at intervals in the axial direction, the heat transfer area is further increased, and the cooling performance of the electric compressor device 1 is further improved.

In the present embodiment, the flow speed of the cooling liquid is increased by setting the aspect ratio to 1 or less. Thus, a flow rate of the cooling liquid can also be reduced. FIG. 3 is a schematic graph showing a relationship between the flow rate and the heat transfer coefficient of the cooling liquid specified through analysis. In the graph in FIG. 3, a solid line indicates the cooling flow channel 40 according to an example having an aspect ratio of 0.25, and a broken line indicates a cooling flow channel (not illustrated) according to a comparative example having an aspect ratio of 1. As described above, the heat transfer coefficient of the cooling flow channel 40 is increased above a heat transfer coefficient of the cooling flow channel according to the comparative example. Consequently, the flow rate of the cooling liquid necessary for implementing a heat transfer coefficient (E shown in the graph) required in the electric compressor device 1 is lower in the cooling flow channel 40 according to the example than in the cooling flow channel according to the comparative example. Accordingly, the flow rate of the cooling liquid flowing through the cooling flow channel 40 can also be reduced in the electric compressor device 1.

The cooling flow channel 40 according to another example may be configured with only the first cooling flow channel 41 without including the second cooling flow channel 42 and the first return cooling flow channel 46. In addition, only one first rib 71 may be provided in the first cooling flow channel 41. These embodiments also achieve the above technical advantages.

### Rib 70 According to Several Embodiments

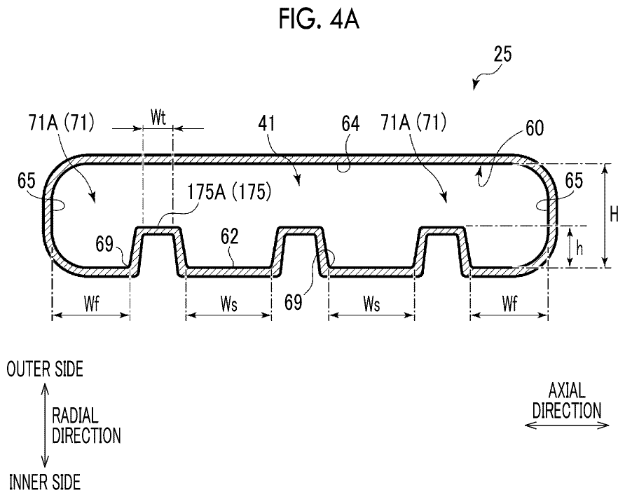

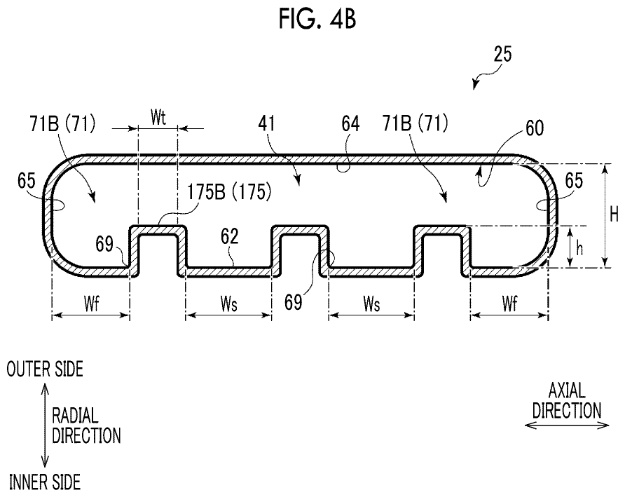

FIGS. 4A and 4B illustrate the first rib 71 constituting the rib 70. FIG. 4A is a schematic cross-sectional view of a first rib 71A (71), and FIG. 4B is a schematic cross-sectional view of a first rib 71B (71). At least one of the configurations related to the first ribs 71A and 71B described below may be applied to the second rib 72 (see FIG. 2).

As illustrated in FIGS. 4A and 4B, maximum lengths (a dimension h) of the first ribs 71A and 71B (71) in the radial direction are ⅘ or less and more preferably ⅔ or less of a maximum length (a dimension H) of the first cooling flow channel 41 in the radial direction. Any value may be adopted as the minimum value of the dimension h. For example, the dimension h may be ⅕ or more and more specifically ⅖ or more of the dimension H.

According to the above configuration, a decrease in the flow rate of the cooling liquid due to an excessively narrow space between the outer radially side wall surface 64 of the motor housing 25 and the first ribs 71A and 71B can be avoided, and an increase in the flow speed of the cooling liquid and a subsequent increase in a pressure loss locally generated in the first cooling flow channel 41 can be avoided.

The above relationship between the dimension h and the dimension H may also be established between the second rib 72 and the second cooling flow channel 42. More specifically, a relationship between lengths of the first rib 71 and the first cooling flow channel 41 in the radial direction and a relationship between lengths of the second rib 72 and the second cooling flow channel 42 in the radial direction may be the same as each other. As a more detailed example, the first rib 71 and the second rib 72 may have the same shape as each other in the view along the circumferential direction, and the first cooling flow channel 41 and the second cooling flow channel 42 may have the same shape as each other in the view along the circumferential direction.

The plurality of first ribs 71A and 71B (71) illustrated in FIGS. 4A and 4B include top portions 175A and 175B (175), respectively, that are outer side ends in the radial direction. The top portion 175 is a flat surface of the first rib 71 facing the outer side in the radial direction and is a flat surface extending orthogonal to the radial direction. Lengths of the top portions 175A and 175B in the axial direction correspond to a dimension Wt. An interval (the shortest distance in the axial direction) between two adjacent first ribs 71A and 71B in the axial direction among the plurality of first ribs 71A and 71B (71) corresponds to a dimension Ws. In the present example, the dimension Ws is larger than the dimension Wt. In other words, the plurality of first ribs 71 are disposed in the axial direction at intervals larger than a length of the top portion 175 in the axial direction. The dimension Wt may be smaller than or larger than the dimension h.

According to the above configuration, an excessive increase in the flow speed of the cooling liquid and a subsequent increase in the pressure loss due to an excessively small interval between two adjacent first ribs 71 can be avoided. The above relationship between the dimension Ws and the dimension Wt may also be established in the second rib 72. That is, the plurality of second ribs 72 may be disposed in the axial direction at intervals larger than a length of a top portion of the second rib 72 in the axial direction.

As illustrated in FIGS. 4A and 4B, the wall surface 60 of the motor housing 25 includes a pair of side surfaces 65 facing the axial direction. In both drawings, the shortest distance between any of the plurality of first ribs 71A and 71B (71) closest to the side surface 65 and the side surface 65 is indicated by a dimension Wf. The dimension Wf is larger than the above dimension Wt. In other words, the shortest distance between the first rib 71 closest to the side surface 65 and the side surface 65 is longer than the length of the top portion 175 in the axial direction.

According to the above configuration, an excessive increase in the flow speed of the cooling liquid and a subsequent increase in the pressure loss due to an excessively short shortest distance between the first rib 71 and the side surface 65 can be avoided. The above relationship between the dimension Wf and the dimension Wt may also be established in the second rib 72. That is, the shortest distance between a side surface (not illustrated) of the wall surface 60 defining the second cooling flow channel 42 and the second rib 72 closest to the side surface may be longer than the length of the top portion of the second rib 72 in the axial direction.

As illustrated in FIGS. 4A and 4B, in the view along the circumferential direction, each of the plurality of first ribs 71A (71) has a trapezoidal shape, and each of the plurality of first ribs 71B (71) has a rectangular shape. In the present example, the first ribs 71A and 71B are connected to the inner radially side wall surface 62 of the wall surface 60 through a curved surface 69. According to the above configuration, for example, manufacturing of the motor housing 25 that may be performed by casting can be facilitated. The above configuration of the first rib 71 may be applied to the second rib 72. That is, in the view along the circumferential direction, the second rib 72 may have a trapezoidal shape or a rectangular shape.

### Detailed Example of Motor Housing 25 and Cooling Flow Channel 40

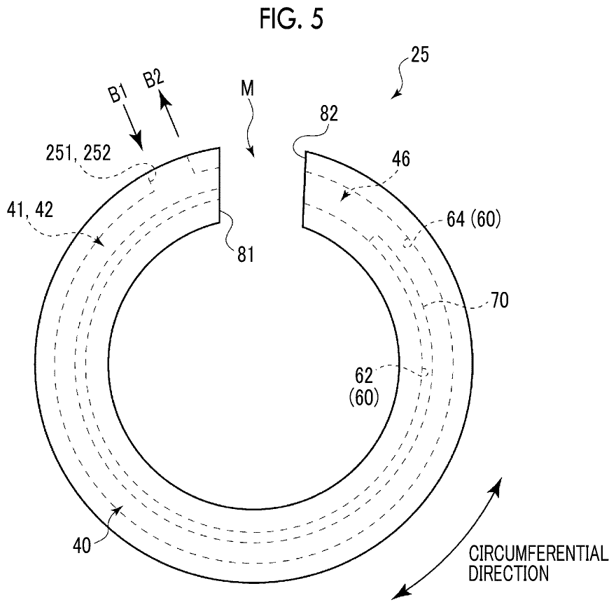

FIG. 5 is a schematic view of the motor housing 25 in the view along the axial direction according to one embodiment of the present disclosure. As illustrated in the drawing, the motor housing 25 includes a first body end portion 81 that is one end portion in the circumferential direction, and a second body end portion 82 that is the other end portion in the circumferential direction. The first body end portion 81 and the second body end portion 82 face each other in the circumferential direction at a gap M therebetween. The motor housing 25 of the present example has a substantially cylindrical shape extending in the axial direction and has a substantially C shape in the view along the axial direction.

FIGS. 6A and 6B illustrate a motor housing 25A (25) according to a first embodiment and a motor housing 25B (25) according to a second embodiment, respectively. Both drawings illustrate unfolded views of the motor housing 25, and vertical directions of the drawings correspond to the circumferential direction (the same applies to FIGS. 6C and 6D described later). In addition, in both drawings, for easy understanding of the drawings, hatching of the rib 70 is different from hatching of the motor housing 25 (the same applies to FIGS. 6C and 6D described later). A cooling flow channel 40A (40) of the motor housings 25A and 25B (25) includes the first cooling flow channel 41 and the second cooling flow channel 42 extending in the circumferential direction, and the first return cooling flow channel 46 communicating with the first cooling flow channel 41 and the second cooling flow channel 42.

In order to implement the above cooling flow channel 40A, a first partition wall 91 is included in the motor housings 25A and 25B (25). The first partition wall 91 extends in the circumferential direction to partition the cooling flow channel 40A into the first cooling flow channel 41, the second cooling flow channel 42, and the first return cooling flow channel 46. More specifically, the first partition wall 91 includes a first connection end portion 911 connected to the first body end portion 81, a first flow channel forming end portion 912 facing the second body end portion 82 in the circumferential direction with the first return cooling flow channel 46 interposed therebetween, and a first extending portion 913 extending in the circumferential direction between the first connection end portion 911 and the first flow channel forming end portion 912. The first extending portion 913 extends parallel to the first rib 71 and the second rib 72. In the examples in FIGS. 6A and 6B, any of a range in which the first cooling flow channel 41 is disposed in the circumferential direction or a range in which the second cooling flow channel 42 is disposed in the circumferential direction is the same as a range in which the first partition wall 91 is disposed in the circumferential direction. The first return cooling flow channel 46 is disposed at a position deviating from the first partition wall 91 in the circumferential direction.

In the examples illustrated in FIGS. 6A and 6B, the inlet 251 is formed in the first cooling flow channel 41, and the outlet 252 is formed in the second cooling flow channel 42. The cooling liquid that has passed through the inlet 251 flows through the first cooling flow channel 41 and then flows through the first return cooling flow channel 46 and the second cooling flow channel 42 in this order and is discharged from the outlet 252.

According to the above configuration, by disposing the first return cooling flow channel 46, the length of the cooling flow channel 40 in the axial direction (in other words, a length of the motor housing 25 in the axial direction) can be increased, and the cooling performance of the electric compressor device 1 is further improved. In addition, by disposing the first return cooling flow channel 46, the cooling liquid is caused to reciprocate in the circumferential direction. Thus, a flow channel length of the cooling flow channel 40 is increased, and the cooling performance of the electric compressor device 1 is improved.

As illustrated in FIG. 6A, all of the ribs 70A (70) according to the first embodiment are disposed to deviate from the first return cooling flow channel 46 in the circumferential direction. More specifically, the first rib 71 and the second rib 72 are disposed within a range deviating from the first return cooling flow channel 46 in the circumferential direction. In the illustrated example, one end portion 711 of the first rib 71 and one end portion 721 of the second rib 72 may be disposed at the same position as the first flow channel forming end portion 912 in the circumferential direction. According to the above configuration, a shape of the motor housing 25A can be simplified, and manufacturing of the motor housing 25A can be facilitated.

As illustrated in FIG. 6B, the rib 70B (70) according to the second embodiment further includes a first curved rib 77 disposed in the first return cooling flow channel 46. The first curved rib 77 is connected to the one end portion 711 of the first rib 71 and the one end portion 721 of the second rib 72 and is curved in an arc shape to be convex to the second body end portion 82. In the present example, a plurality of first curved ribs 77 are disposed, and each first curved rib 77 is connected to the one end portion 711 of each first rib 71 and the one end portion 721 of each second rib 72.

According to the above configuration, a heat transfer area in the first return cooling flow channel 46 can be increased, and the cooling performance of the electric compressor device 1 is further improved. In addition, the cooling liquid can flow along the first curved rib 77 in the first return cooling flow channel 46, and the pressure loss of the cooling liquid in the first return cooling flow channel 46 can be reduced.

### Detailed Example of Motor Housing 25 and Cooling Flow Channel 40 According to Other Embodiments

FIGS. 6C and 6D illustrate a motor housing 25° C. (25) according to a third embodiment and a motor housing 25D (25) according to a fourth embodiment, respectively. A cooling flow channel 40B (40) of the motor housings 25C and 25D (25) further includes a third cooling flow channel 43 and a second return cooling flow channel 48, in addition to the first cooling flow channel 41, the second cooling flow channel 42, and the first return cooling flow channel 46. The third cooling flow channel 43 is arranged together with the first cooling flow channel 41 and the second cooling flow channel 42 in the axial direction and extends in the circumferential direction. The second return cooling flow channel 48 communicates with the second cooling flow channel 42 and the third cooling flow channel 43. Ribs 70C and 70D (70) illustrated further include a third rib 73 extending in the circumferential direction in the third cooling flow channel 43, in addition to the first rib 71 and the second rib 72. In the present example, three third ribs 73 are disposed at intervals in the axial direction in the third cooling flow channel 43.

The motor housings 25C and 25D (25) illustrated in FIGS. 6C and 6D further include a second partition wall 92. The second partition wall 92 extends in the circumferential direction to partition the cooling flow channels 40C and 40D (40) into the second cooling flow channel 42 and the third cooling flow channel 43. More specifically, the second partition wall 92 includes a second connection end portion 921 connected to the second body end portion 82, a second flow channel forming end portion 922 facing the first body end portion 81 in the circumferential direction with the second return cooling flow channel 48 interposed therebetween, and a second extending portion 923 extending in the circumferential direction between the second connection end portion 921 and the second flow channel forming end portion 922. The second extending portion 923 extends parallel to the second rib 72 and the third rib 73.

In the examples in FIGS. 6C and 6D, the second return cooling flow channel 48 is disposed at a position deviating from the second rib 72 and the third rib 73 in the circumferential direction. Lengths of the first rib 71 and the third rib 73 in the circumferential direction are equal to each other, and a length of the second rib 72 in the circumferential direction is smaller than the lengths of the first rib 71 and the third rib 73 in the circumferential direction. In the examples in both drawings, lengths of the first cooling flow channel 41 and the third cooling flow channel 43 in the circumferential direction are equal to each other, and a length of the second cooling flow channel 42 in the circumferential direction is smaller than the lengths of the first cooling flow channel 41 and the third cooling flow channel 43 in the circumferential direction. A length in the circumferential direction and a length in the axial direction of the second return cooling flow channel 48 are equal to the length in the circumferential direction and the length in the axial direction of the first cooling flow channel 41, respectively.

In the motor housings 25C and 25D (25) illustrated in FIGS. 6C and 6D, the inlet 251 is formed in the first cooling flow channel 41, and the outlet 252 is formed in the third cooling flow channel 43. The cooling liquid that has passed through the inlet 251 flows through the first cooling flow channel 41, the first return cooling flow channel 46, the second cooling flow channel 42, the second return cooling flow channel 48, and the third cooling flow channel 43 in this order and is discharged from the outlet 252.

According to the above configuration, by disposing the second return cooling flow channel 48 in addition to the first return cooling flow channel 46, the length of the cooling flow channel 40 in the axial direction (in other words, the length of the motor housing 25 in the axial direction) can be increased, and the cooling performance of the electric compressor device 1 is further improved. In addition, by further disposing the second return cooling flow channel 48, the number of times the cooling liquid reciprocates in the circumferential direction is increased. Thus, the flow channel length of the cooling flow channel 40 is increased, and the cooling performance of the electric compressor device 1 is improved.

In the rib 70C (70) illustrated in FIG. 6C, the second rib 72 and the third rib 73 are disposed within a range deviating from the second return cooling flow channel 48 in the circumferential direction. The other end portion 722 of the second rib 72 and one end portion 731 of the third rib 73 may be disposed at the same position as the second flow channel forming end portion 922 in the circumferential direction. According to the above configuration, a shape of the motor housing 25C can be simplified, and manufacturing of the motor housing 25C can be facilitated.

The rib 70D (70) illustrated in FIG. 6D further includes a second curved rib 78 disposed in the second return cooling flow channel 48. The second curved rib 78 is connected to the other end portion 722 of the second rib 72 and the one end portion 731 of the third rib 73 and is curved in an arc shape to be convex to the first body end portion 81. In the present example, a plurality of second curved ribs 78 are disposed, and each second curved rib 78 is connected to the other end portion 722 of each second rib 72 and the one end portion 731 of each third rib 73.

According to the above configuration, a heat transfer area in the second return cooling flow channel 48 can be increased, and the cooling performance of the electric compressor device 1 is further improved. In addition, the cooling liquid can flow along the second curved rib 78 in the second return cooling flow channel 48, and the pressure loss of the cooling liquid in the second return cooling flow channel 48 can be reduced.

### Other Modification Examples

The electric compressor device 1 is not limited to the two-stage compression electric compressor illustrated in FIG. 1. The electric compressor device 1 may be a single-stage compression electric compressor incorporated in a turbocharger device.

A length of the first curved rib 77 in the radial direction may be smaller than at least one of a length of the first rib 71 in the radial direction or a length of the second rib 72 in the radial direction. In this case, the cooling liquid flowing along the first curved rib 77 in the first return cooling flow channel 46 can flow over the first curved rib 77. Thus, a pressure loss in the first return cooling flow channel 46 can be reduced.

The first curved rib 77 is not limited to extending continuously between the one end portion 711 of the first rib 71 and the one end portion 721 of the second rib 72. A first through-hole passing through the first curved rib 77 in the circumferential direction may be formed in the first curved rib 77. For example, the first curved rib 77 may include a first connection curved rib extending in an arc shape from the one end portion 711 and a second connection curved rib extending in an arc shape from the one end portion 721, and a gap as the first through-hole may be formed between the first connection curved rib and the second connection curved rib. The first connection curved rib and the second connection curved rib have radii of curvature equal to each other. In this case, the cooling liquid flowing through the first return cooling flow channel 46 can also pass through the gap, and heat transfer in the first return cooling flow channel 46 can be improved compared to that in a case where the flow of the cooling liquid along the circumferential direction is restricted by the first curved rib 77.

Similarly, the second curved rib 78 is not limited to extending continuously between the other end portion 722 of the second rib 72 and the one end portion 731 of the third rib 73. A second through-hole passing through the second curved rib 78 in the circumferential direction may be formed in the second curved rib 78. For example, the second curved rib 78 may include a third connection curved rib extending in an arc shape from the other end portion 722 and a fourth connection curved rib extending in an arc shape from the one end portion 731, and a gap as the second through-hole may be formed between the third connection curved rib and the fourth connection curved rib. The third connection curved rib and the fourth connection curved rib have radii of curvature equal to each other. In this case, the cooling liquid flowing through the second return cooling flow channel 48 can also pass through the gap, and heat transfer in the second return cooling flow channel 48 can be improved compared to that in a case where the flow of the cooling liquid along the circumferential direction is restricted by the second curved rib 78.

### Summary

For example, the above contents according to several embodiments are understood as follows.

1) An electric compressor device (1) according to at least one embodiment of the present disclosure includes a rotating shaft (2), a compressor wheel (at least one of the low-pressure stage wheel 13 or the high-pressure stage wheel 14) provided on the rotating shaft, a motor (5) for driving the rotating shaft, and a motor housing (25) accommodating the motor, in which the motor includes a rotor (51) fixed to the rotating shaft, and a stator (52) that is disposed around the rotor and that is supported by the motor housing, in the motor housing, a cooling flow channel (40) for causing a cooling liquid to flow along a circumferential direction is formed on an outer side in a radial direction with respect to the stator, in a view along the circumferential direction, a length of the cooling flow channel in an axial direction is larger than a length of the cooling flow channel in a radial direction by a factor of two or more, and at least one rib (70) that protrudes to the outer side in the radial direction from an inner radially side wall surface (62) of a wall surface (60) of the motor housing defining the cooling flow channel and that extends in the circumferential direction is provided.

According to the above configuration of 1), since an aspect ratio of the cooling flow channel is less than 1, a flow speed of the cooling liquid in the cooling flow channel is increased. In addition, a flow channel cross-sectional area is appropriately reduced by providing the at least one rib. Thus, the flow speed of the cooling liquid is further increased. Accordingly, a heat transfer coefficient between the cooling flow channel and the cooling liquid is increased. A heat transfer area is also increased by providing the rib. Thus, the electric compressor device having improved cooling performance is implemented.

2) In several embodiments, in the electric compressor device according to 1), a radial direction length of the rib is ⅘ or less of a maximum radial direction length of the cooling flow channel.

According to the above configuration of 2), a decrease in a flow rate of the cooling liquid due to an excessively narrow cooling flow channel because of the rib can be avoided, and an increase in the flow speed of the cooling liquid and a subsequent increase in a pressure loss locally generated in the cooling flow channel can be avoided.

3) In several embodiments, in the electric compressor device according to 1) or 2), the at least one rib is disposed at a plurality of spaced intervals in the axial direction.

According to the above configuration of 3), the heat transfer area is further increased. Thus, the cooling performance of the electric compressor device is further improved.

4) In several embodiments, in the electric compressor device according to 3), each of a plurality of the ribs includes a top portion (175) that is an outer side end in the radial direction, and the plurality of ribs are disposed in the axial direction at intervals larger than a length of the top portion in the axial direction.

According to the above configuration of 4), an excessive increase in the flow speed of the cooling liquid and a subsequent increase in the pressure loss due to an excessively small interval between two adjacent ribs can be avoided.

5) In several embodiments, in the electric compressor device according to 4), in the view along the circumferential direction, each of the plurality of ribs has a trapezoidal shape or a rectangular shape.

According to the above configuration of 5), manufacturing of the motor housing can be facilitated.

6) In several embodiments, in the electric compressor device according to any one of 3) to 5), each of a plurality of the ribs includes a top portion (175) that is an outer side end in the radial direction, the wall surface of the motor housing is a surface facing the axial direction and includes a side surface (65) defining the cooling flow channel, and a distance between the rib closest to the side surface and the side surface is longer than a length of the top portion in the axial direction.

According to the above configuration of 6), an excessive increase in the flow speed of the cooling liquid and a subsequent increase in the pressure loss due to an excessively short distance between the rib and the side surface can be avoided.

7) In several embodiments, in the electric compressor device according to any one of 3) to 6), the number of ribs disposed in the cooling flow channel extending in the circumferential direction is three or more.

According to the above configuration of 7), the heat transfer area is further increased. Thus, the cooling performance of the electric compressor device is further improved.

8) In several embodiments, in the electric compressor device according to any one of 1) to 7), the motor housing includes a first body end portion (81) that is one end portion in the circumferential direction, a second body end portion (82) that is the other end portion in the circumferential direction and that faces the first body end portion with a gap (M) between the first body end portion and the second body end portion, and a first partition wall (91) extending in the circumferential direction to partition the cooling flow channel into a first cooling flow channel (41) and a second cooling flow channel (42) arranged in the axial direction, and a first return cooling flow channel (46) communicating with the first cooling flow channel and the second cooling flow channel, and the first partition wall includes a first connection end portion (911) connected to the first body end portion, and a first flow channel forming end portion (912) facing the second body end portion in the circumferential direction with the first return cooling flow channel interposed between the second body end portion and the first flow channel forming end portion.

According to the above configuration of 8), by providing the first return cooling flow channel in the cooling flow channel, the length of the cooling flow channel in the axial direction can be increased, and the cooling performance of the electric compressor device is further improved.

9) In several embodiments, in the electric compressor device according to 8), the at least one rib is provided, and all of the ribs are disposed to deviate from the first return cooling flow channel in the circumferential direction.

According to the above configuration of 9), manufacturing of the motor housing can be facilitated.

10) In several embodiments, in the electric compressor device according to 8), the at least one rib includes a first rib (71) extending in the circumferential direction in the first cooling flow channel, a second rib (72) extending in the circumferential direction in the second cooling flow channel, and a curved rib (the first curved rib 77) that is curved to be convex to the second body end portion in the first return cooling flow channel and that is connected to one end portion (711) of the first rib and one end portion (721) of the second rib.

According to the above configuration of 10), a heat transfer area in the first return cooling flow channel can be increased. Thus, the cooling performance of the electric compressor device is further improved. In addition, the cooling liquid can flow along the curved rib in the first return cooling flow channel, and a pressure loss of the cooling liquid in the first return cooling flow channel can be reduced.

11) In several embodiments, in the electric compressor device according to any one of 8) to 10), the motor housing further includes a second partition wall (92) extending in the circumferential direction to partition the cooling flow channel into the second cooling flow channel and a third cooling flow channel (43) arranged in the axial direction, and a second return cooling flow channel (48) communicating with the second cooling flow channel and the third cooling flow channel, and the second partition wall includes a second connection end portion (921) connected to the second body end portion, and a second flow channel forming end portion (922) facing the first body end portion in the circumferential direction with the second return cooling flow channel interposed between the first body end portion and the second flow channel forming end portion.

According to the above configuration of 11), by further providing the second return cooling flow channel in the cooling flow channel, the length of the cooling flow channel in the axial direction can be further increased, and the cooling performance of the electric compressor device is further improved.

### REFERENCE SIGNS LIST

1: electric compressor device
2: rotating shaft
3: low-pressure stage compressor
4: high-pressure stage compressor
5: motor
13: low-pressure stage wheel
14: high-pressure stage wheel
20: housing
23: low-pressure side housing
24: high-pressure side housing
25: motor housing
40: cooling flow channel
41: first cooling flow channel
42: second cooling flow channel
43: third cooling flow channel
46: first return cooling flow channel
48: second return cooling flow channel
51: rotor
52: stator
53: stator core
54: stator coil
60: wall surface
62: inner radially side wall surface
64: outer radially side wall surface
65: side surface
69: curved surface
70: rib
71: first rib
72: second rib
73: third rib
77: first curved rib
78: second curved rib
81: first body end portion
82: second body end portion
91: first partition wall
92: second partition wall
175: top portion
236, 246: intake port
237, 247: diffuser
238, 248: scroll portion
251: inlet
252: outlet
711, 721, 731: one end portion
722: other end portion
911: first connection end portion
912: first flow channel forming end portion
913: first extending portion
921: second connection end portion
922: second flow channel forming end portion
923: second extending portion
M: gap

1. An electric compressor device comprising:
a rotating shaft;
a compressor wheel provided on the rotating shaft;
a motor for driving the rotating shaft; and
a motor housing accommodating the motor,
wherein the motor includes
a rotor fixed to the rotating shaft, and
a stator that is disposed around the rotor and that is supported by the motor housing,
in the motor housing, a cooling flow channel for causing a cooling liquid to flow along a circumferential direction is formed on an outer side in a radial direction with respect to the stator,
in a view along the circumferential direction, a length of the cooling flow channel in an axial direction is larger than a length of the cooling flow channel in the radial direction by a factor of two or more, and
at least one rib that protrudes to the outer side in the radial direction from an inner radially side wall surface of a wall surface of the motor housing defining the cooling flow channel and that extends in the circumferential direction is provided.

2. The electric compressor device according to claim 1, wherein a radial direction length of the rib is ⅘ or less of a maximum radial direction length of the cooling flow channel.

3. The electric compressor device according to claim 1,
wherein the at least one rib is disposed at a plurality of spaced intervals in the axial direction.

4. The electric compressor device according to claim 3,
wherein each of a plurality of the ribs includes a top portion that is an outer side end in the radial direction, and
the plurality of ribs are disposed in the axial direction at intervals larger than a length of the top portion in the axial direction.

5. The electric compressor device according to claim 4,
wherein, in the view along the circumferential direction, each of the plurality of ribs has a trapezoidal shape or a rectangular shape.

6. The electric compressor device according to claim 3,
wherein each of a plurality of the ribs includes a top portion that is an outer side end in the radial direction,
the wall surface of the motor housing is a surface facing the axial direction and includes a side surface defining the cooling flow channel, and
a distance between the rib closest to the side surface and the side surface is longer than a length of the top portion in the axial direction.

7. The electric compressor device according to claim 3,
wherein the number of ribs disposed in the cooling flow channel extending in the circumferential direction is three or more.

8. The electric compressor device according to claim 1,
wherein the motor housing includes
a first body end portion that is one end portion in the circumferential direction,
a second body end portion that is the other end portion in the circumferential direction and that faces the first body end portion with a gap between the first body end portion and the second body end portion, and
a first partition wall extending in the circumferential direction to partition the cooling flow channel into a first cooling flow channel and a second cooling flow channel arranged in the axial direction, and a first return cooling flow channel communicating with the first cooling flow channel and the second cooling flow channel, and
the first partition wall includes
a first connection end portion connected to the first body end portion, and
a first flow channel forming end portion facing the second body end portion in the circumferential direction with the first return cooling flow channel interposed between the second body end portion and the first flow channel forming end portion.

9. The electric compressor device according to claim 8,
wherein the at least one rib is provided, and all of the ribs are disposed to deviate from the first return cooling flow channel in the circumferential direction.

10. The electric compressor device according to claim 8,
wherein the at least one rib includes
a first rib extending in the circumferential direction in the first cooling flow channel,
a second rib extending in the circumferential direction in the second cooling flow channel, and
a curved rib that is curved to be convex to the second body end portion in the first return cooling flow channel and that is connected to one end portion of the first rib and one end portion of the second rib.

11. The electric compressor device according to claim 8,
wherein the motor housing further includes
a second partition wall extending in the circumferential direction to partition the cooling flow channel into the second cooling flow channel and a third cooling flow channel arranged in the axial direction, and a second return cooling flow channel communicating with the second cooling flow channel and the third cooling flow channel, and
the second partition wall includes
a second connection end portion connected to the second body end portion, and
a second flow channel forming end portion facing the first body end portion in the circumferential direction with the second return cooling flow channel interposed between the first body end portion and the second flow channel forming end portion.
